(19) United States
(12) Patent Application Publication
(10) Pub. No.: US 2006/0200773 A1
(43) Pub. Date: Sep. 7, 2006

(54) Apparatus method and article of manufacture for visualizing status in a compute environment

(76) Inventors: David Nocera, Martinsville, NJ (US); Lorelei Wagner, New Port Richey, FL (US)

Correspondence Address: Goodwin Procter, 103 Eisenhower Parkway, Roseland, NJ, 07068, US

(21) Appl. No.: 10/542,112

(22) PCT Filed: Jan. 13, 2004
(86) PCT No.: PCT/US04/00784

§ 371 Date: Apr. 7, 2006

(30) Foreign Application Priority Data
Jan. 13, 2003 (US) 60439696

(51) Int. Cl. G06F 3/00

(52) U.S. Cl. 715/764

(57) ABSTRACT

There is provided herein an exemplary technique utilizing at least one application status icon for visualizing the status of important metrics of, e.g., one or more applications running within a compute infrastructure. In an exemplary embodiment, the application status icon is located on a device display, preferably as part of a graphical user interface icon tray, such as Microsoft® Windows® system tray. To generate the appropriate color of the application status icon, several predefined test or database queries are executed lo determine the status of a desired application. Thereafter, the determined status is compared to a plurality of threshold conditions, which determine the state of a given status metric and contribute to the overall color of the application status icon, preferably located on the display device. Thus, a user or manager need not run an application to check its status. Instead, the manager need only view the color of the application status icon on the display device to determine the overall health of a plurality of underlying metrics, which contribute to the creation of the application status icon's color.

The present invention relates generally to compute and/or network management and more particularly to an improved system, method, apparatus, and article of manufacture for graphically reporting status on a compute infrastructure.

### BACKGROUND OF THE INVENTION

Heretofore, compute infrastructure status visualization techniques involve the use of multiple and various applications that are generally specialized, large and complex, all monopolizing desktop resources and usually requiring special training. Determining status on important metrics such as business, application, and technology or production issues involves interaction with one or more of these complex applications, multiple key strokes and complex application interaction to generate reports, which are then consolidated from multiple sources and summarized for management. The process is often time-consuming and cumbersome and requires special training and skills. Furthermore, the existing applications are geared for proficient computer or network operators, not managers. Because of time constraints, busy managers generally do not have time to even review the summary reports.

Accordingly, what is needed is a further summary of the summary report. That is, a comprehensive way to visualize status on a compute infrastructure, and more particularly, a simple solution that detects status from multiple sources or metrics, consolidates them, summarizes what it consolidated and displays the entire status as a single icon on a manager's display device—desktop, from which the underlying detail can be displayed via drilldown. The drilldown should include certain critical information, so that managers can take appropriate action when necessary.

### SUMMARY OF THE INVENTION

The present solution addresses the aforementioned problems of the prior art by providing for, among other things, an improved apparatus, method and article of manufacture for visualizing status of important metrics. Specifically, there is provided herein an exemplary technique utilizing at least one status icon for visually reporting the status of at least the important metrics of a resource, e.g., one or more applications running within a compute infrastructure. In an exemplary embodiment, the application status icon is located on a device display, preferably as part of a graphical user interface icon tray, such as Microsoft® Windows® system tray. To generate the appropriate color of the application status icon, several predefined tests or database queries are executed to determine the status of a desired application. Thereafter, the determined status is compared to a plurality of threshold conditions, which determine the state of a given status metric and contribute to the overall color of the application status icon, preferably located on the display device. Thus, a user or manager need not run an application to check its status. Instead, the manager need only view the color of the application status icon on the display device to determine the overall health of a plurality of underlying metrics, which contribute to the creation of the application status icon's color.

If a problem exists with any metric color of the single main application, the icon changes from good to bad. A problem is defined as one or more metrics falling outside the range of a predefined and acceptable threshold condition. Upon drilldown, the color of the icon used to present the metric is also changed from good to bad.

### BRIEF DESCRIPTION OF THE DRAWINGS

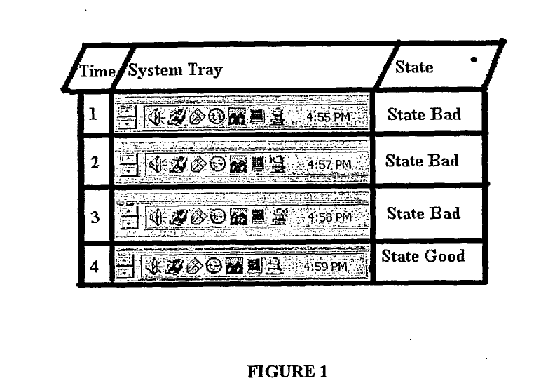

Referring briefly to the drawings, embodiments of the present invention will be described with reference to the accompanying drawings in which FIGS. 1, 2 and 3 illustrate certain aspects and features of the present solution.

### DETAILED DESCRIPTION OF THE INVENTION

Referring more specifically to the drawings, for illustrative purposes the present invention may be embodied in the graphical image/interface, method of operation and article of manufacture or product, generally shown in FIGS. 1, 2 and 3. It will be appreciated that the graphical image/interface, method of operation and article of manufacture may vary as to the details of its representative icons (a square may be a circle), configuration (the exact screen layout may be adjusted) and operation without departing from the basic concepts disclosed herein. The following description, which follows with reference to certain embodiments herein, is, therefore, not to be taken in a limiting sense.

There is provided herein an exemplary method utilizing at least one status icon for visually reporting the status of at least the important metrics of a resource, e.g., one or more applications running within a compute infrastructure. The status icon also implements a real time summary drill-down status report of the resource, 11 e.g. an application. In an exemplary embodiment, the status icon is located on a device display, preferably as part of a graphical user interface icon tray, such as. Microsoft® Windows® system tray.

FIG. 1 depicts the status icon as part of the Microsoft® Windows® system tray. The icon can be programmed to summarize the state of multiple metrics over various time intervals. For example, at Time 1, 2 and 3, the status icon is red, reflecting a bad state. At Time 4, the status icon is green, reflecting a good state. Preferably, a single graphical icon is utilized to summarize the state of the underlying metrics within a compute infrastructure. Thus, if the icon is green, thus indicating a good state, management can be assured that the important metrics of the given resource(s) are good. Alternatively, if the icon is red, thus indicating a bad state, management can take action with the appropriate people.

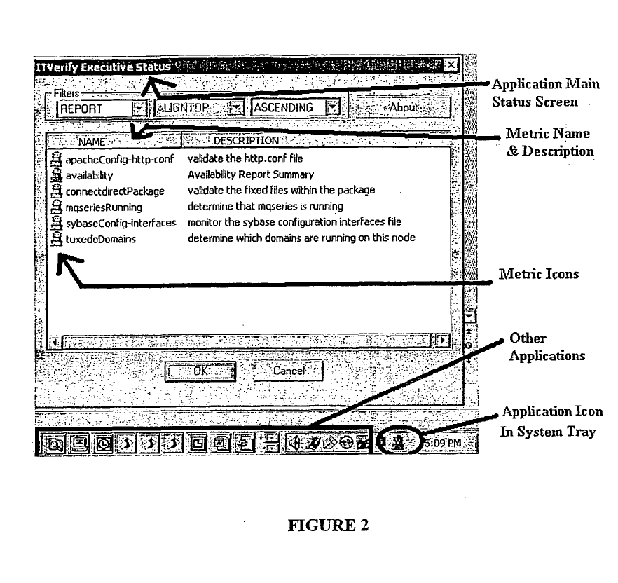

FIG. 2 depicts the first level of drilldown for taking action when the icon is red, thus indicating a bad state. The first level of drilldown for taking action is the main status window/object (hereinafter referred to as application main status screen). The application main status screen is accessed and displayed when the user selects/clicks on the status icon. Each metric icon displayed in the application main status screen, represents a single metric or a container of multiple metrics. The states of the metrics contribute collectively to the overall state reported by the status icon. A single metric might also be associated with a test or query that can aggregate multiple “hidden” metrics and summarize the results into a single value (e.g. Service Levels).

FIG. 2 also depicts the various resources/applications running on the computing device. Many of these applications are also depicted in the system tray together with the status icon. Using the system tray elevates the executive level attention for metrics contained in this application, constantly reporting their status in real time. This allows the status for important issues, reflected in the state of important metrics to be elevated above the “noise” of the other applications on the busy display device.

Also shown in FIG. 2, prior use of the system tray uses single icons to represent the state of single applications (e.g. NetMeeting) or monitors (e.g. CPU Usage). This invention uses a single icon to represent the state of multiple and dissimilar metrics from multiple and dissimilar sources, presented and summarized to management as a single icon. This makes better use of the system tray, leveraging the fact that the system tray is always visible, to allow important metrics to also always be visible to management.

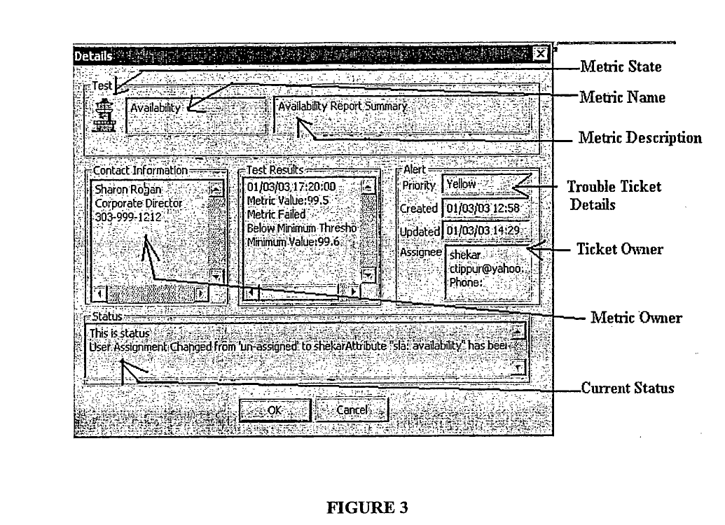

FIG. 3 depicts self explanatory details that are used to manage metrics. Not-illustrated, but disclosed is the graphing of historical metric data in a variety of formats (e.g. line, bar, pie) charts.

In accordance with another aspect of the present invention, there is provided an exemplary system, method, apparatus and product for visualizing status on a compute infrastructure wherein an application is used as a container for important metrics to be managed by an application.

In accordance with another aspect of the present invention, there is provided an exemplary system, method, apparatus and product for visualizing status on a compute infrastructure wherein a main status icon for the application is provided on a display device associated with a device running Microsoft's Windows-based operating system. The icon is preferably displayed as part of the Windows System Tray and may also be positioned ahead of other icons in the System Tray.

In accordance with another aspect of the present invention, there is provided an exemplary system, method, apparatus and product for visualizing status on a compute infrastructure wherein the main status icon is an iconized (minimized) Windows application, or any application in a windowing environment (e.g. X Windows).

In accordance with another aspect of the present invention, there is provided an exemplary system, method, apparatus and product for visualizing status on a compute infrastructure wherein the color of the main status icon changes to reflect the underlying state of important metrics associated with the application.

In accordance with another aspect of the present invention, there is provided an exemplary system, method, apparatus and product for visualizing status on a compute infrastructure wherein the metrics are configurable.

In accordance with another aspect of the present invention, there is provided an exemplary system, method, apparatus and product for visualizing status on a compute infrastructure wherein the conditions that trigger the changed state of a metric are configurable.

In accordance with another aspect of the present invention, there is provided an exemplary system, method, apparatus and product for visualizing status on a compute infrastructure wherein the application can manage other instances of itself, as a container of metrics or other instances of the application. In accordance with another aspect of the present invention, there is provided an exemplary system, method, apparatus and product for visualizing status on a compute infrastructure wherein the specific colors of the main icon represent multiple levels of severity conditions.

In accordance with another aspect of the present invention, there is provided an exemplary system, method, apparatus and product for visualizing status on a compute infra-structure wherein the specific shape or image of the main icon represent multiple levels of severity conditions.

In accordance with another aspect of the present invention, there is provided an exemplary system, method, apparatus and product for visualizing status on a compute infrastructure wherein ignored metrics do not contribute to the color of the main icon.

In accordance with another aspect of the present invention, there is provided an exemplary system, method, apparatus and product for visualizing status on a compute infrastructure wherein the metrics can be ignored based upon time (such as a snooze alarm)

In accordance with another aspect of the present invention, there is provided an exemplary system, method, apparatus and product for visualizing status on a compute infrastructure wherein the main icons are modifiable and animated.

In accordance with another aspect of the present invention, there is provided an exemplary system, method, apparatus and product for visualizing status on a compute infrastructure wherein a click (or drilldown) on the icon shows at least one list of icons that contain either at least one metric, or at least one icon representing another instance of the application (which may be reflecting more applications or more metrics).

In accordance with another aspect of the present invention, there is provided an exemplary system, method, apparatus and product for visualizing status on a compute infrastructure wherein individual metrics are populated as a result of running tests on a compute infrastructure.

In accordance with another aspect of the present invention, there is provided an exemplary system, method, apparatus and product for visualizing status on a compute infrastructure wherein a single test can aggregate the results of multiple important things, into a metric of higher importance (e.g. Service Level Compliance).

In accordance with another aspect of the present invention, there is provided an exemplary system, method, apparatus and product for visualizing status on a compute infrastructure wherein individual metrics are the result of queries to a predefined dynamic updatable database.

In accordance with another aspect of the present invention, there is provided an exemplary system, method, apparatus and product for visualizing status on a compute infrastructure wherein the display name of the test, as viewed by the user, can be different from the actual test name as required to gather information.

In accordance with another aspect of the present invention, there is provided an exemplary system, method, apparatus and product for visualizing status on a compute infrastructure wherein the details describing the test and thresholds are configurable.

In accordance with another aspect of the present invention, there is provided an exemplary system, method, apparatus and product for visualizing status on a compute infrastructure wherein the contact information including but not limited to a business owner and the a trouble ticket assignee is displayable.

In accordance with another aspect of the present invention, there is provided an exemplary system, method, apparatus and product for visualizing status on a compute infrastructure wherein an Alert, Alarm or Fault is associated with each metric, coming from one of many trouble ticket systems.

In accordance with another aspect of the present invention, there is provided an exemplary system, method, apparatus and product for visualizing status on a compute infrastructure wherein the status of the Alert, Alarm or Fault is tracked, including but not limited to Alert Level, Priority, Creation Data, Ticket Number, Assignee.

In accordance with another aspect of the present invention, there is provided an exemplary system, method, apparatus and product for visualizing status on a compute infrastructure wherein the historical performance of the metric can be observed.

In accordance with another aspect of the present invention, there is provided an exemplary system, method, apparatus and product for visualizing status on a compute infrastructure wherein multiple levels of historical performance can be observed (e.g. hourly, weekly, monthly).

In accordance with another aspect of the present invention, there is provided an exemplary method of visualizing status on a compute infrastructure wherein the method can be employed or embedded within any application, as a means to report status within the application, for any metrics that is internal and/or external to the application.

In accordance with another aspect of the present invention, there is piovided an exemplary system, method, apparatus and product for visualizing status on a compute infrastructure wherein the main status icon can be located anywhere on the display device.

In accordance with another aspect of the present invention, there is provided an exemplary system, method, apparatus and product for visualizing status on a compute infrastructure wherein the status icon need not be graphical but can also consist of text, video, audio or a combination thereof.

Conclusion

Having now described an exemplary of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

Moreover, the techniques may be implemented in hardware or software, or a combination of the two. In one embodiment, the techniques are implemented in computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, hard disk-or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

1. A computer-implemented method of visually reporting the status of a resource having one or more status metrics associated therewith, said resource executing within a compute infrastructure, said method comprising:
generating a color changeable status icon associated with said resource; associating a different color to said color changeable status icon to reflect the underlying state of said one or more status metrics;
comparing said one or more status metrics to a plurality of threshold conditions to determine the underlying state of said one or more status metrics;
displaying the appropriate color of said application status icon based on said comparison.

2. The method as in claim 1 wherein wherein the resource is used as a container for important metrics to be managed by the resource.

3. The method as in claim 1 wherein wherein the status icon is provided on a display device associated with a device running Microsoft's Windows-based operating system; said icon is displayed as part of the Windows System Tray.

4. The method as in claim 1 wherein the status icon is an iconized (minimized) Windows application, or any application in a windowing environment (e.g. X Windows).

5. The method as in claim 1 wherein the metrics are configurable.

6. The method as in claim 1 wherein the conditions that trigger the changed state of a metric are configurable.

7. The method as in claim 1 wherein the resource can manage other instances of itself, as a container of metrics or other instances of the resource.

8. The method as in claim 1 wherein the specific colors of the status icon represent multiple levels of severity conditions.

9. The method as in claim 1 wherein the specific shape or image of the status icon represents multiple levels of severity conditions.

10. The method as in claim 1 wherein the status icon is modifiable and animated.

11. The method as in claim 1 wherein a click (or drilldown) on the icon shows at least one list of icons that contain either at least one metric, or at least one icon representing another instance of the application (which may be reflecting more applications or more metrics).

12. The method as in claim 1 wherein the one or more metrics are determined as a result of running tests on a compute infrastructure.

13. The method as in claim 1 wherein a single test can aggregate the results of multiple important items, into a metric of higher importance (e.g. Service Level Compliance).

14. The method as in claim 1 wherein said one or more metrics are the result of queries to a predefined dynamic updatable database.

15. The method as in claim 1 wherein the display name of the test, as viewed by the user, can be different from the actual test name as required to gather information.

16. The method as in claim 1 wherein the details describing the test and thresholds are configurable.

17. The method as in claim 1 wherein the contact information including but not limited to a business owner and the a trouble ticket assignee is displayable.

18. The method as in claim 1 wherein an Alert, Alarm or Fault is associated with each metric, coming from one of many trouble ticket systems.

19. The method as in claim 1 wherein the status of the Alert, Alarm or Fault is tracked, including but not limited to Alert Level, Priority, Creation Data, Ticket Number, Assignee.

20. The method as in claim 1 wherein the-historical performance of the metric can be observed.

21. The method as in claim 1 wherein multiple levels of historical performance can be observed (e.g. hourly, weekly, monthly).

22. The method as in claim 1 wherein the status icon can be located anywhere on the display device.

23. The method as in claim 1 wherein the status icon consists of graphics, text, video, audio or a combination thereof.
